(19) United States
(12) Patent Application Publication
(10) Pub. No.: US 2008/0140685 A1
(43) Pub. Date: Jun. 12, 2008

(54) APPARATUS AND METHOD FOR MANAGEMENT OF CONTENT

(75) Inventors: Gyu-baek Kim, Yongin-si (KR); Hyung-chan Kim, Yongin-si (KR); Nam-geol Lee, Seoul (KR); Ji-yeon Jeong, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/831,008

(22) Filed: Jul. 31, 2007

(30) Foreign Application Priority Data
Dec. 8, 2006 (KR) 2006-124844

(51) Int. Cl. G06F 17/30

(52) U.S. Cl. 707/100; 707/E17.125

(57) ABSTRACT

An apparatus for managing content including a property-modeling unit for defining properties in a predetermined format according to the content types, a category-managing-unit for creating categories mapped to the content type, a UI-providing unit for providing a screen on which property-information values are input according to the types of the generated categories, a mapping unit for mapping the property-information values to a predetermined content file. The property-information value includes one or more sets of information regarding the authority information and/or the price model of the content where each set is capable of including both the authority information and the price model.

### CROSS-REFERENCE TO RELATED APPLICATION

This application claims the benefit of Korean Patent Application No. 2006-124844, filed Dec. 8, 2006 in the Korean Intellectual Property Office, the disclosure of which is incorporated herein in its entirety by reference.

### BACKGROUND OF THE INVENTION

1. Field of the Invention

Aspects of the present invention relate to a method and apparatus for managing content, and more particularly to a method and apparatus for managing content that provides digital rights management (DRM) services and billing services by adopting the right to use the content and the property-information value for a price model to predetermined content.

2. Description of the Related Art

A variety of quality content is an important factor in service and products. A content management system (CMS) has been introduced for companies for the efficient managing, sharing, and distributing of large bodies of documents and other content. The CMS may support: managing documents of groupware in the company, managing images and videos connected to a website, and managing mobile contents to provide ring tone-download services. Further, the content is becoming more diverse and now includes user-created content (UCC). In this situation, the biggest issue is adoption of a variety of price policies for DRM and billing. For example, according to Japanese Unexamined Patent Publication No. 2003-345707 describes a method of setting the individual conditions and environments for end users of the contents, and capsulating the contents in a DRM manner customized for the conditions and environments to thereby protect and circulate the contents.

FIG. 1 is a conceptual diagram illustrating how the conventional DRM service is provided. DRM standards are different depending on the adopted field and products. As illustrated in FIG. 1, during packaging 12, the original content is first encrypted using the specific encryption keys to provide the DRM service. As such, the encrypted content and the encryption key are generated. The encryption key is used to reconstruct the original content.

Rights modeling 14 is the process for setting predetermined restrictions that are applied when the encrypted content is used. For example, the right to permit the restriction of playing a predetermined content up to three times can be modeled. The DRM-protected content 16 is created through this process. Then, when a client uses the DRM content 16 in a specific platform 20, the encryption key and the authority information necessary for decryption are requested to a license server 10. The license server 10 reads the encryption key and the authority information, and sends the read key and authority information to the client's platform 20.

As such, the method used when the DRM system is connected to the CMS can be divided into two methods. The first method manages the content that is supported by the DRM through additional tools after registering the additional tools, similar to general content. However, a content administrator has to perform separately on both systems related to the DRM and the CMS, and the tool provided by the DRM-related enterprise is functionally duplicated with the CMS. Also, only the DRM-protected content can be input to the CMS, and the original content, without the DRM support, cannot be used in other systems through the CMS.

The second method adds a user interface (UI) to the CMS menu for packaging and rights modeling necessary for the DRM service. However, customizing and developing generate costs due to the difficulty in connecting the CMS and the DRM systems. In addition, a variety of DRM standards cannot be efficiently applied to the CMS as only one DRM method is supported. Further, it is difficult to relate the content management system UI and the DRM-related UI; and additionally, a database to store the DRM-related information is needed.

FIG. 2 is a conceptual diagram of a conventional billing service. Generally, the billing is sourced from a call data record (CDR) or a usage data record (UDR), and the data is transmitted through an arbitrating module 30. The transmitted data passes through a validation process 32, such as formatting and filtering. After passing through the validation process 32, data for calculating bills is extracted. Then, bill rating 34 is performed using the extracted data.

At this time, since the billing is determined according to the price policy of a service provider, a price model must be referred to. For example, every time a content file is downloaded, a fee of 100 won, or about $0.10, is charged. When the number of downloads reaches 10, the price model can be set such that the 10th download is free. After the bill rating 34 is finalized, fee data 36 is created. Also, the created fee data 36 can be provided to a billing center, a customer center, and the CRM.

As such, a method used when the billing system is connected to the CMS is divided into two methods. The first method is to model the price policy with respect to the content through an additional tool (price editor) and register the content in the CMS. The price-related information and the content-related tables are stored in the additional database, and the content and the price are mapped using the content identifier (CID). Therefore, the price model designated in the corresponding contents is adopted. However, this is inconvenient as the content managing administrator has to perform work separately in two systems related to the billing and the CMS, and the price editor tool provided by the billing system is functionally duplicated in the CMS.

The second method is to add a user interface (UI) for modeling prices in the CMS menu. However, customizing and developing generate costs due to the difficulty in connecting the CMS and the billing system with regards to the content management enterprises and the billing enterprises. In addition, a variety of price models cannot be efficiently applied to one CMS as only one price model can be applied. Further, it is difficult to relate the content management system UI and the billing-related UI; and additionally, a database for storing the billing-related information is needed.

Therefore, a system is required for efficiently providing the DRM service and the billing services through assigning property-information values for authority information and a price model related to predetermined content.

### SUMMARY OF THE INVENTION

Aspects of the present invention provide a method and apparatus for managing content and efficiently connecting the DRM system and the billing service.

Aspects of the invention provide an apparatus to manage content, the apparatus including a property-modeling unit to define properties in a predetermined format according to the content types, a category-managing unit to generate categories mapped to the content type, a UI-providing unit to provide a screen through which property-information values are input according to the types of generated categories, a mapping unit to map and apply the property-information values to the predetermined content file. The property-information value includes one or more set of information regarding the authority information and/or the price model of the content.

Aspects of the invention provided a method of managing contents, the method including defining properties in a predetermined format applicable to a predetermined content file according to the content types, generating categories to which the content types are mapped, defining property-information values for the defined properties according to the generated categories, mapping the property-information values to the predetermined content file. The property-information values are selectable and include one or more sets of information regarding the authority information or the price model of the content.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating how operation of a DRM service;

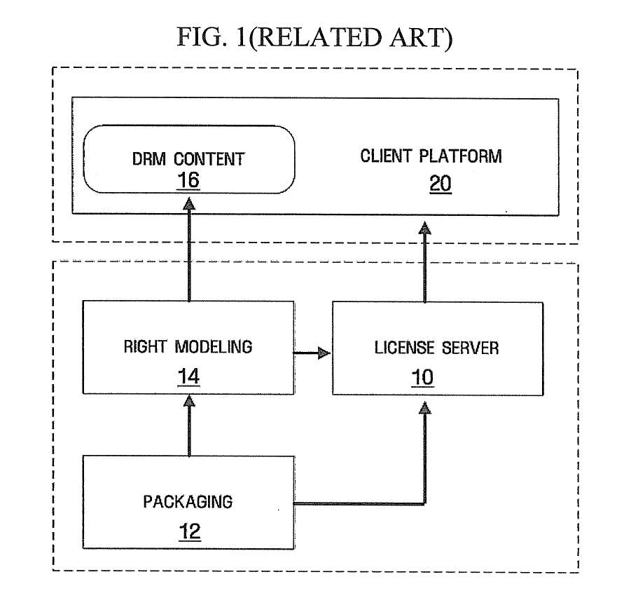

FIG. 2 is a diagram of operation of a billing service;

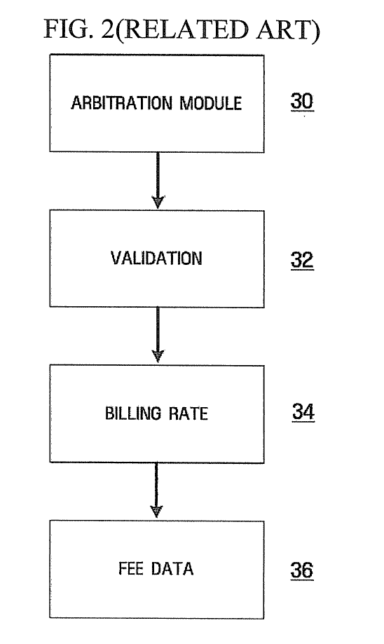

FIG. 3 is a block diagram of a content-management device according to aspects of the present invention;

FIG. 4 illustrates a screen to define the properties according to aspects of the present invention;

FIG. 5 illustrates a category-management screen according to aspects of the present invention;

FIG. 6 illustrates a screen to input the DRM property information according to aspects of the present invention;

FIG. 7 illustrates a screen to input the property information of the billing according to aspects of the present invention;

FIG. 8 illustrates a screen to input content according to aspects of the present invention; and

FIG. 9 is a flowchart of the method of managing content according to aspects of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

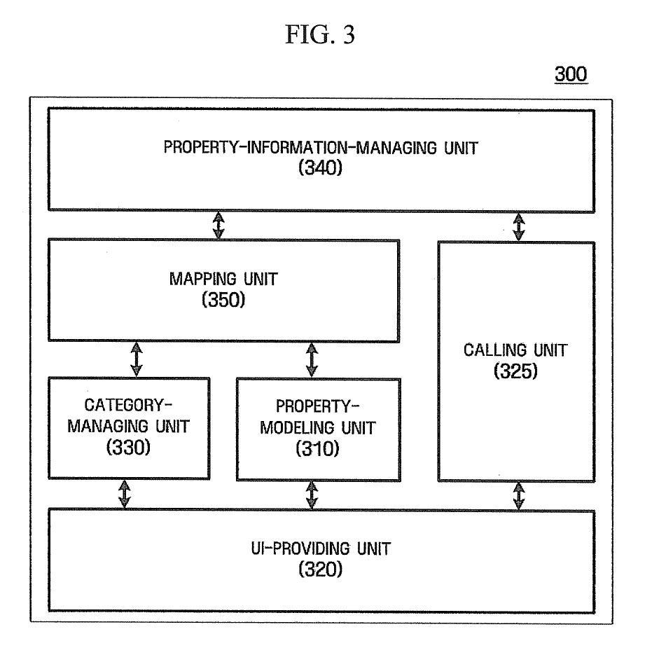

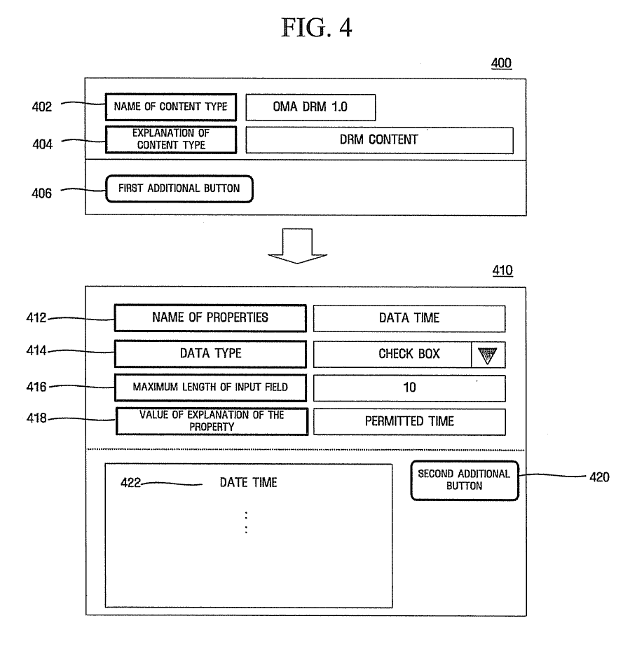

FIG. 3 is a block diagram illustrating a content management device according to aspects of the present invention. The content management device 300 includes a property-modeling unit 310, a UI-providing unit 320, a calling unit 325, a category-managing unit 330, a property-information managing unit 340, and a mapping unit 350. However, the content management device 300 is not limited thereto. For example, the content management device 300 may include other units or one or several of the units may be broken into multiple other units or combined with other units in other aspects of the invention. Moreover, the content management device 300 could be implemented on one or more servers whereby a user could, from a remote computer having content, associate properties with the content through interfaces shown in FIGS. 4 through 8 across a network.

The property-modeling unit 310 defines the properties in a predetermined format according to the content types. The property-modeling unit 310 manages the properties of the content, or predetermined content files, by grouping them into content types. The content types include videos, images, audio recordings, video games, tools, calendars, executable programs, and the like. For example, the properties of the videos managed by the property-modeling unit 310 may include the frame per second (FPS), size, height, width, and the like. The horizontal and vertical sizes can be included in the properties of the images managed by the property-modeling unit 310. The content types may be broad or narrow such that different predetermined content files may be included in multiple different content types. The information regarding the rights of the content license (constraints and permissions) can be managed by the property-modeling unit 310 as a content type related to the DRM. The authority information regarding the rights associated with the content license may include the period permitted for using the content, the number of permitted plays, and the number of permitted users. However, the information regarding the rights associated with the content license may also include regional limitations or format limitations such that the content can only be manipulated by approved devices. The price model of the content can be managed as a content type related to the content billing. Examples of the price model include basic fees, interest rates, discount rates, billing and payment histories, and the like.

As illustrated in FIG. 4, the user can add the properties according to the content type through a screen 400 provided by the UI-providing unit 320. Here, the added properties are grouped as the name of one content type 402. For example, the DRM-related properties can be included as the named content type (OMA DRM 1.0).

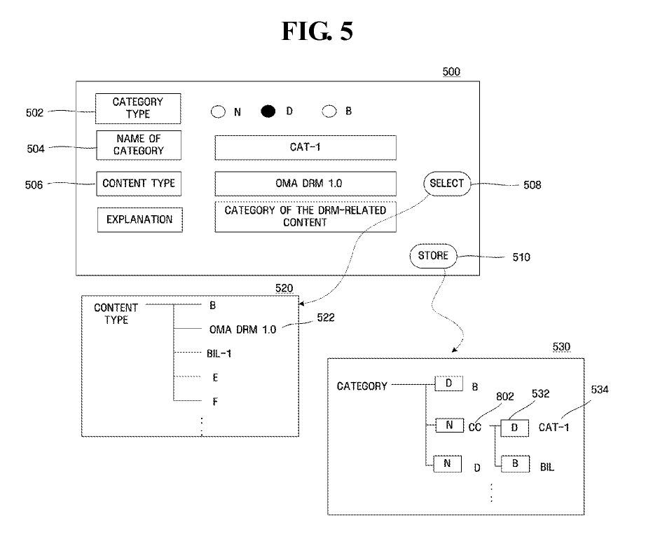

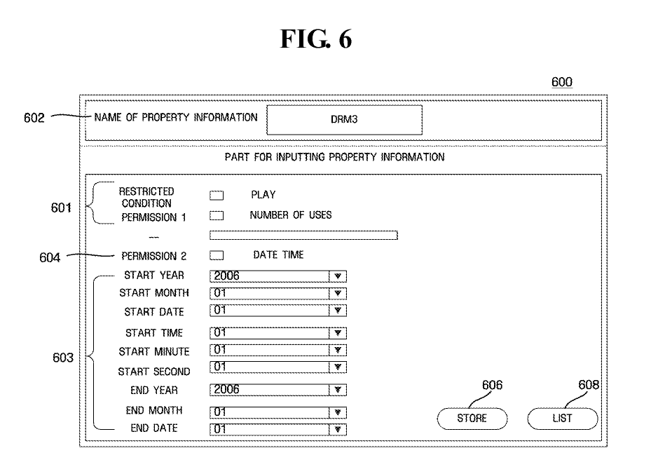

Referring to FIG. 3, the UI-providing unit 320 provides a screen to input information. For example, as illustrated in FIG. 4, the UI-providing unit 320 may provide a screen 410 to display the defined or added properties of the content. Also, as illustrated in FIG. 5, the UI-providing unit 320 provides a category management screen 500. As illustrated in FIGS. 6 to 8, the UI-providing unit 320 provides screens 600, 700, and 800 to input the properties according to the category type. As such, the UI-providing unit 320 provides a variety of screens into which data may be input. Further, the UI-providing unit 320 need not to be a visual display, but may be any form of communication of the properties of the content to a user. For example, the UI-providing unit 320 could provide and receive audio commands, or be a device such as a personal computer, laptop, cellular phone, camera, audio player, server, or the like having the display or connected to the display.

The calling unit 325 modifies source code related to the operation of programs and designates a DRM encryption process. That is, the DRM has a variety of encryption standards, and an external library corresponding to the DRM encryption standard can be called in order to perform the DRM encryption with respect to predetermined content. Therefore, a predetermined executable code is easily input through a predetermined screen provided by the Ul-providing unit 320, and the external library is called according to the content input to content management device 300, thereby providing for customized service.

Referring again to FIG. 3, the category-managing unit 330 generates and manages categories mapped to the content type. That is, when the content is registered through a specific category, a property not yet input is determined by mapping the content type during the process of generating the category. For efficient management, the categories are managed according to the types and content uses. For example, the categories may be defined as neutral (N), DRM (D), and billing (B). However, the categories are not limited thereto. Categories such as free (F) or clear (C) may be included. By way of example, the user selects the DRM (D) category in the category-management screen 500 as illustrated in FIG. 5, and inputs the name of the category 504 as CAT-1, and selects the name of a predetermined content type 506 including the DRM-related properties among the names of the content type generated in FIG. 4. In such example, the user selected the DRM-related properties of the content type named OMA DRM 1.0.

Then, the selected name of the content type is mapped with category CAT-1 through the mapping unit 350 of FIG. 3. Next, when the user clicks a store button 510, the CAT-1 category is generated to which the name of the selected content type (OMA DRM 1.0) is mapped, and the generated category (CAT-1) is arranged at a position in a category tree structure. As such, the generated category arranged in the tree structure is mapped to a previously generated category of a higher level in the category tree structure—a level having fewer generated categories. Here, the DRM-related properties content type named OMA DRM 1.0 has been mapped to the category CAT-1. The category CAT-1 has been saved and arranged in a tree structure comprising other categories. As such, there are levels of categories established; however, the arrangement of the categories need not be limited to a tree structure. The categories may be arranged in any suitable format or database structure.

Referring again to FIG. 3, the property-information-managing unit 340 stores and manages values of the property information input in the screen provided by the UI-providing unit 320. Specifically, first, the user selects one of the categories generated for inputting property information of the content, and inputs the property information values through the screen 500 provided according to the selected category as in FIG. 5. That is, when the category mapped with a predetermined content type is generated by the category-managing unit 330, the user selects the generated category. Then, the properties defined in the name of the content type mapped to the generated category are displayed on the screen 500. The user inputs the actual property information value via the screen, and the property-information-managing unit 340 stores and manages the input information. The property information values may include a number of days in which a song is available for play, a price per download, or a number of uses, etc.

The mapping unit 350 maps the input values of the property information to a predetermined content file, and applies the values of the mapped property information to the predetermined content file. At this time, the value of the property information may include one or more pieces of information regarding the authority of the content and the price model of the content. Also, the mapping unit 350 maps sets of content that are related to each other. For example, the content of a song in MP3 format and the music video for the same song are related in that they comprise content from the same artist, the same album, the same title, etc. Therefore, the related contents are mapped by the mapping unit 350 through a predetermined screen, and the mapped contents are recommended resulting in improved service and sales.

The term “unit”, as used herein, means, but is not limited to, a software or hardware component, such as a Field Programmable Gate Array (FPGA) or an Application Specific Integrated Circuit (ASIC), which performs certain tasks. A unit may advantageously be configured to reside on the addressable storage medium and to execute on one or more processors. Thus, a “unit” may include, by way of example, components, such as software components, object-oriented software components, class components and task components, process, functions, attributes, procedures, subroutines, segments of program code, drivers, firmware, microcode, circuitry, data, databases, data structures, tables, arrays, variables, etc. The functionality provided for in the components and units may be combined into fewer components and units or further separated into additional components and units.

FIG. 4 illustrates a first input screen 400 to input and define the properties of the content type according to aspects of the present invention. The properties for each content type can be generated through the first and second input screens 400 and 410. As illustrated in FIG. 4, when the DRM-related properties are generated, the user inputs the value for a name of the content type 402 and an explanation of the content type 404 in the first input screen 400. Here, it is illustrated that the user input the name of the content type 402 as OMA DRM 1.0, and the explanation of the content type 404 as DRM content. The input value is stored in a database table (tMoCm_ContentTypeInfo) as shown in a Table 1.

TABLE 1
tMoCm_ContentTypeInfo

| COLUMN NAME | TYPE | NULL | EXPLANATION | IS PK | IS FK |
|---|---|---|---|---|---|
| sContentType | NVARCHAR2(100) | NULL | NAME OF THE | YES | NO |
| | | | CONTENT TYPE | | |
| sDesc | NVARCHAR2(400) | NOT NULL | EXPLANATION OF | NO | NO |
| | | | THE CONTENT TYPE | | |

Then, by pressing a first additional button 406, a second input screen 410 through which the properties are input is provided. The user may input the name of the properties 412, a data type 414, a maximum value of the input length 416, and a value of an explanation of the property 418. However, the properties are not limited thereto. A minimum value of the input length may be included. Further, all inputs discussed may be selected from predetermined inputs, such as predetermined category names or predetermined content type names, or the user may generate the inputs. For example, the DRM-related property may include the permitted period for using the content. Therefore, when the permitted period is added as the property, the date/time (i.e., data time) is input in the name of the properties 412 and a check box is selected as the data type 414. The data type 414 includes a text field, a text area, a check box, a combo box, and a radio button, and the user selects one of them. However, the data type 414 is not limited thereto such that the data type may be generated and input by a user or includes other names for data types. In this situation, when the actual value of the property information is input, the user selects the date/time check box, and applies the permitted time period for the content to be used.

When the user clicks a second additional button 420 after inputting the values for the rest of the property fields 414, 416, and 418, the user can confirm that the date/time has been added as the date/time 422 appears on the screen 410. After the date/time is added, the user can add other properties using the method mentioned above. The added properties are managed as associated with the name of the content type 402. In this example, the name of the content type 402 is OMA DRM 1.0. The second input screen 410 includes a variety of fields other than the property fields 412, 414, 416, and 418. With a click of the second additional button 420, the input values are stored in database table (tMoCm_ContentItem) as shown in a

TABLE 2
tMoCm_ContentItem

| COLUMN NAME | TYPE | NULL | EXPLANATION | IS PK | IS FK |
|---|---|---|---|---|---|
| sContent type | NVARCHAR2(100) | NOT NULL | NAME OF THE CONTENT TYPE | YES | YES |
| sItemName | NVARCHAR2(100) | NOT NULL | NAME OF THE PROPERTIES | YES | NO |
| sItemDataType | VARCHAR2(20) | NULL | DATA TYPE | NO | NO |
| iMaxLength | DECIMAL(10) | NULL | MAXIMUM VALUE OF | NO | NO |
| | | | THE INPUT LENGTH | | |
| sDesc | NVARCHAR2(400) | NULL | VALUE OF EXPLANATION | NO | NO |
| | | | OF THE PROPER [symbol] | | |

[symbol]

indicates data missing or illegible when filed

Other properties related to the general content are added in the same manner and are stored in the database table Table 2. As an example for general content, the name of the content type 402 may be input as Content-1 in the first input screen 400, and the explanation of the content type 404 may be input as general content. The name of the properties 412 may be input as ID in the second input screen 410, the data type 414 for inputting the properties for ID is selected as a text field, the maximum length of the input field 416 may be 20 bytes, and an ID is input as a value of the explanation of the property 418. By pressing the second additional button 420, the second input values are stored in the Table 2 (tMoCm_ContentItem). Then, the generated properties are managed as the name of the content type 402 (Content-1).

The principle can be used to add properties related to the billing method (basic fee, discount rate, exemption rate, etc). Therefore, properties of the content related to the general content, DRM, and billing can be managed in the same format using the described screens 400, 410 to input the information regarding the content type.

In addition, the values to be used in inputting the actual property information with respect to the data type 414 are coded in the database table (tMoCm_ContentItemCode) as shown in a Table 3. For example, when the data type 414 is select to input a gender type associated with the content is added as a property in the combo box format (radio button or check box), the inputting format is displayed on a screen to input the actual property information so that male or female can be selected. Here, the code value can be provided according to the gender selected by the user. For example, the code value 1 can be provided for the code name (male), and the code value 0 can be provided for the code name (female). Then, they are stored in a database table as shown in Table 3. (tMoCm_ContentItemCode).

TABLE 3
tMoCm_ContentItemCode

| COLUMN NAME | TYPE | NULL | EXPLANATION | IS PK | IS FK |
|---|---|---|---|---|---|
| sContent type | NVARCHAR2(100) | NOT NULL | NAME OF THE CONTENT TYPE | YES | YES |
| sItemName | NVARCHAR2(100) | NOT NULL | NAME OF THE PROPERTIES | YES | YES |
| sCodeName | NVARCHAR2(100) | NOT NULL | CODE NAME TO BE | YES | NO |
| | | | USED IN THE PROPER [symbol] | | |
| sCode | NVARCHAR2(100) | NULL | CODE VALUE TO BE | NO | NO |
| | | | USED IN THE PROPE [symbol] | | |

[symbol]

indicates data missing or illegible when filed

FIG. 5 illustrates a category-management screen 500 according to aspects of the present invention. As illustrated in FIG. 5, the category type 502 is divided into neutral (N), DRM (D), and billing (B), but the category type 502 is not limited thereto. The user selects DRM (D) in the category type 502 of the category management screen 500, and inputs the name of the category 504 as CAT-1. The user clicks a selection button 508 with respect to a content type 506, and selects OMA DRM 1.0 522 among the names of the content type generated in FIG. 4. The name of the content type can be provided to the user in a content type tree structure 520, but is not limited thereto. When the content type is arranged in the content type tree structure 520 as shown, the content type may be mapped to a content type of a higher level—a level having fewer content types. The name of the content type may be provided in the form of a searchable index or require the user to generate the name of the content type. As shown, the tree includes a content type B, OMA DRM 1.0, BIL-1, E, and F, which can be selected. When the user selects OMA DRM 1.0 522, OMA DRM 1.0 522 is mapped to CAT-1. Next, when the user clicks a save button 510, the CAT-1 category is generated to which OMA DRM 1.0 522 is mapped.

Then, the generated CAT-1 category 534 is arranged at a predetermined position with relation to a category that was generated in advance on a category tree structure 530. However, the generated categories need not be limited to a category tree structure such that the categories may be arranged such that the categories are retrievable as in a star configuration. Next, an identifier 532 to indicate the category type can be provided in a display of the category name indicated in the category tree structure 530. As shown in the category tree structure 530, an identifier D can correspond to category type B, and identifier N can correspond to category type CC 802 or category type D. For identifier N, where the category type CC 802 is used, and identifier 532 for the category CAT-1 534 can be chosen, as can category BIL having an identifier B.

Here, the arrangement or the position of the generated category (i.e., how deeply the generated category is located from the upper category which was generated in advance), and the values for the basic information of the category as input by the user in the management screen 500, are stored in the database table (tMoCm_Category) as indicated in Table 4.

TABLE 4
tMoCm_Category

| COLUMN NAME | TYPE | NULL | EXPLANATION | IS PK | IS FK |
|---|---|---|---|---|---|
| sCatId | VARCHAR2(24) | NOT NULL | CATEGORY ID | YES | NO |
| sClass | VARCHAR2(20) | NOT NULL | CATEGORY TYPE | YES | NO |
| | | | (Normal, DRM, Billing) | | |
| sCatName | NVARCHAR2(200) | NULL | CATEGORY NAME | NO | NO |
| sUpperCatId | VARCHAR2(24) | NULL | UPPER CATEGORY ID | NO | NO |
| iDepth | DECIMAL(5) | NULL | DEPTH VALUE OF | NO | NO |
| | | | THE CORRESPONDING [symbol] | | |
| iSeq | DECIMAL(5) | NULL | ORDER OF THE CATEGORIES | NO | NO |
| | | | HAVING THE [symbol] | | |
| sDesc | NVARCHAR2(400) | NULL | EXLANATION | NO | NO |

[symbol]

indicates data missing or illegible when filed

Also, the information mapped with the content type and the category is stored in database table (tMoCm_ContentCatDef) as indicated in Table 5.

TABLE 5
tMoCm_ContentCatDef

| COLUMN NAME | TYPE | NULL | EXPLANATION | IS PK | IS FK |
|---|---|---|---|---|---|
| sCatId | VARCHAR2(24) | NOT NULL | CATEGORY ID | YES | YES |
| sContentType | NVARCHAR2(100) | NOT NULL | CONTENT TYPE | YES | YES |
| sClass | VARCHAR2(20) | NOT NULL | CATEGORY USES | YES | YES |
| | | | (Normal, DRM, Billing) | | |

As illustrated in Table 5, the name of a content type (OMA DRM 1.0) generated in FIG. 4 and a category ID granted to the category (CAT-1) generated in FIG. 5 are stored with the information regarding the type of the selected category, thereby being mapped to one another.

Meanwhile, when the DRM (D) category is selected and the user clicks the store button 510 as shown in FIG. 5, the user can call the external library which may be needed for coding or encrypting the DRM according to the information input by the user through a screen (not shown) to input executable codes additionally provided by the Ul-providing unit 320. For example, when the user clicks the store button 510 and a code (e.g., “ret=transfor(input file, output file, key)”) is added through the screen, the user inputs the proper value in a parameter value of the code so that the external library needed for coding the DRM can be called. Therefore, the service is customized with respect to a variety of DRM specifications that can be provided.

Further, when the user clicks the store button 510, the category tree structure 530 is generated through a screen 800 to be described below.

FIG. 6 illustrates a screen to input the DRM property information according to aspects of the present invention. The user selects one of the categories generated to input the property information of the content, and inputs the property information through the screen thereby inputting the property information provided according to the selected category. For example, when the DRM(D) category is selected in FIG. 5, the property of content type OMA DRM 1.0 mapped to the CAT-1 is indicated on a screen 600 on which the DRM property information as shown in FIG. 6.

The values input in the screen 600 on which the DRM property information is shown are stored in a database table (tMoCm_ContentItemVal) shown in Table 6. The database table Table 6 (tMoCm_ContentItemVal) includes the property information values actually input for the properties according the content type generated in FIG. 4.

TABLE 6
tMoCm_ContentItemVal

| COLUMN NAME | TYPE | NULL | EXPLANATION | IS PK | IS FK |
|---|---|---|---|---|---|
| sContentType | NVARCHAR2(100) | NOT NULL | CONTENT TYPE NAME | YES | YES |
| sItemName | NVARCHAR2(100) | NOT NULL | PROPERTY NAME | YES | YES |
| sContentId | VARCHAR2(24) | NOT NULL | CONTENT ID | YES | YES |
| sVal | NVARCHAR2(2000) | NOT NULL | INFORMATION VALUE | NO | NO |
| | | | OF THE INPUT PRO [symbol] | | |

[symbol]

indicates data missing or illegible when filed

Specifically, the name of property information 602 is input as DRM3 in the screen 600 through which the DRM property information is input. The actual property values with respect to the properties are also input through the screen 600. For reference, the name of property information 602 is input in sItemName of Table 6.

For example, the name of the properties 412 is input as the date/time in FIG. 4, and the data type 414 is added to the check box as a property, and stored as the content type name OMA DRM 1.0. Then, the property name (date/time) 412 and a check box 414 appear on the screen 600 through which the DRM property information is input as permission 2 604, and the user can select whether to apply the previously defined permission 2 604, including the date/time 412 information, to DRM3. Further, the user can input actual property information values to further define the properties, such as start date, hour, minute, second, as well as end date, month, and year of the license in property information values 603. Similarly, other properties, such as property 601, included in the name of the content type OMA DRM 1.0 generated in FIG. 4 appear on the screen 600 through which the DRM property information is input according to the defined format. The user clicks a store button 606, and stores the input values. The stored property information is treated as one set of content with one name (DRM3). Then, the information generated through a list button 608 can be confirmed or reviewed.

As described above, the property information with respect to the content is dynamically created and managed, which is different in that the content information regarding each content is fixed and stored in a predetermined database table. Therefore, the property information can be applied to a variety of content more easily.

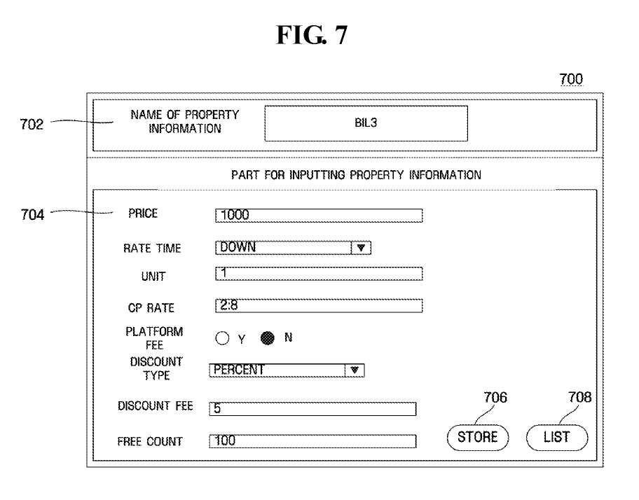

As illustrated in FIG. 7, the property information for the billing can be input in the same manner as that of FIG. 6. FIG. 7 illustrates a screen 700 in which the property information of the billing is input according to aspects of the present invention. The user generates the billing-related properties as the name of the content type (BIL-1) through FIG. 4, and selects the category type as billing (B) in FIG. 5. Then, the user inputs the category name BIL and which is then stored after mapping it with the content type BIL-1 as shown in screen 520. Thereafter, the user selects the generated category BIL, and inputs the property information regarding the price model associated with the content illustrated in FIG. 7 through a screen 700 through which the property information of the billing is input.

Specifically, for example, when the name of the properties 412 is input as PRICE as the property, which is included in the name of content type (BIL-1), and the data type 414 is input as a text field, a price and a text field 704 appear on the screen 700 through which the property information of the billing is input, and the user inputs the price to apply it to the content type named BIL-1. Similarly, other properties, such as UNIT and CP RATE, associated with the name of the content type (BIL-1) generated in FIG. 4 appear on the screen for inputting the property information of the billing 700 according to the defined format. The user clicks a store button 706 and stores the input values, and the stored property information is stored and managed under the name of BIL3 702. Then the generated information of the property information can be confirmed or reviewed through a list button 708. The values input in the screen 700 through which the property information of the billing are input are stored in tMoCm_ContentItemVal as shown in Table 6 similar to the storage of the data associated with DRM 3 as described above.

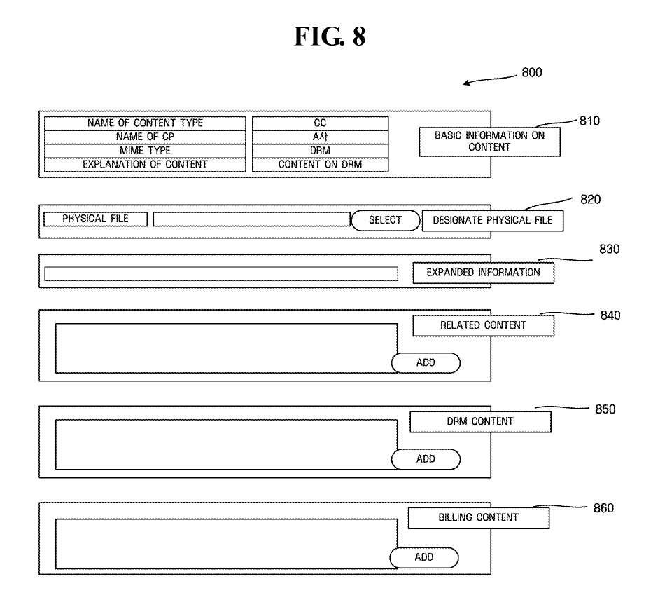

FIG. 8 illustrates a screen for inputting content according to aspects of the present invention. First, the user selects the category in which to register the content. For example, CC 802 is one category among the categories generated in FIG. 6 and shown in the category tree structure 530 of FIG. 5, CC 802 is selected. Then, a screen 800 through which the content is input, such as that of FIG. 8, is provided. The screen 800 varies according to the type of the selected category (for example: N, D, and B as described above in regards to FIG. 5). That is, the screens 600 and 700 for inputting property information values of FIGS. 6 and 7 are the screens through which basic information associated with the content 810 are input and expanded information 830 is produced through the screen 800 through which the content is input. As shown, the basic information 810 includes the name of the category (CC 802), the name of the content provider (A Co.), the mime type (DRM), and the explanation of the content (content on DRM). The expanded information 830 allows for the property information associated with FIGS. 6 and 7 to be input. Therefore, the values input in the expanded information 830 are stored in Table 6 (tMoCm_ContentItemVal) as described above.

When the user selects the category in which to register the content in FIG. 8, the user is presented with the previously defined categories and selects one of the previously defined content types (CC 802). The category CC 802 selected in FIG. 8 is of the neutral (N) category as shown in FIG. 5, and as such, may be a selection of videos having similar properties, such as a play-time length of over one minute, as defined through the screen 410 in FIG. 4. The user is able to explain the nature of the content to be added to the selected category CC 802. In FIG. 8, the user has explained that content on DRM is to be added as the explanation of content. As such, the user would input information into the DRM content 850 portion of the screen. In the above-described examples, the user would select the category CAT-1 including content type OMA DRM 1.0 (as assigned to CAT-1 in FIG. 5) for which property-information values have been applied through DRM3 in FIG. 6 (as defined in FIG. 6) for properties associated with OMA DRM 1.0 (as defined in FIG. 4).

Billing content 860 is also be added to the category CC 802 as illustrated in the category tree structure 530 in FIG. 5, using the above-described process. While not shown, to add the billing properties for CC 802, the category BIL with the property-information values (BIL3) for properties (PRICE from FIG. 7) for the content type (BIL-1 from above) associated with the category BIL would be selected instead of CAT-1. As such, the screen 800 through which content is input allows a user to place different content types having different properties and property-information values in categories in the category tree structure 530. Furthermore, a user can specifically add content to the selected category 802 by designating the physical file 820. Expanded information 830 and related content 840 may also be input through the screen 800.

The basic information associated with the content 810 is stored in the database table tMoCm_ContentInfo as shown in a Table 7.

TABLE 7
tMoCm_ContentInfo

| COLUMN NAME | TYPE | NULL | EXPLANATION | IS PK | IS FK |
|---|---|---|---|---|---|
| sContentId | VARCHAR2(24) | NOT NULL | CONTENT ID | YES | NO |
| sContentName | NVARCHAR2(200) | NOT NULL | CONTENT TYPE NAME | NO | NO |
| sDesc | NVARCHAR2(400) | NULL | EXPLANATION ON CONTENT TYPE | NO | NO |
| sFileName | NVARCHAR2(400) | NULL | CONTENT FILE NAME | NO | NO |
| | | | (INCLUDING ROUTE) | | |
| sRegister | VARCHAR2(24) | NULL | REGISTER | NO | NO |
| dDate | DATE | NOT NULL | DATE OF CONTENT REGISTRATION | NO | NO |
| sMimeType | VARCHAR2(100) | NULL | INFORMATION ON MIME TYPE | NO | NO |

Meanwhile, the actual physical file is selected by a physical file designation 820. In this way, the content (i.e., audio, video, image, software, document file) is associated with the properties associated with the category CC 802. Related content 840 may be mapped to the actual physical file as designated by the physical file designation 820. For example, by designating the content file related to the content file selected in the physical file designation 820, the mapped content file can be recommended to customer in the future to thereby increase sales.

The mapping information between contents is stored in the table of database (tMoCm_ContentRelation) as shown in a Table 8.

TABLE 8
tMoCm_ContentRelation

| COLUMN NAME | TYPE | NULL | EXPLANATION | IS PK | IS FK |
|---|---|---|---|---|---|
| sContentId | VARCHAR2(24) | NOT NULL | CONTENT ID | YES | YES |
| sRelatedContentId | VARCHAR2(24) | NOT NULL | RELEVANT OTHER | YES | NO |
| | | | CONTENT ID | | |

The DRM content 850 may be selected as one of the sets of information (e.g., DRM3) generated by the category of the DRM (D) type, as shown in FIG. 6, through the DRM content selector 850 of the screen 800. Through the mapping process, the DRM authority can be applied to the content selected by the physical file designation 820. At this time, a variety of pieces of authority information can be simultaneously applied by selecting a plurality of sets of property information generated in advance. In addition, a price model can be mapped to the content selected by the physical file designation 820 by selecting one of the sets of information (e.g., BIL3) generated in a portion of the screen 800 for inputting the billing content 860 as designated by the category of the billing (B) type, as illustrated in FIG. 7. Similarly, a number of the property information values with respect to the billing can be designated.

The category is selected when the predetermined content is registered as mentioned above. The information regarding the location of the predetermined content is stored in the database table (tMoCm_ContentCatRef) as shown in Table 9.

TABLE 9
tMoCm_ContentCatRef

| COLUMN NAME | TYPE | NULL | EXPLANATION | IS PK | IS FK |
|---|---|---|---|---|---|
| sCatId | VARCHAR2(24) | NOT NULL | CATEGORY ID | YES | YES |
| sContentId | VARCHAR2(24) | NOT NULL | CONTENT ID | YES | YES |
| sClass | VARCHAR2(20) | NOT NULL | CATEGORY TYPE | YES | YES |
| | | | (Normal, DRM, Billing) | | |

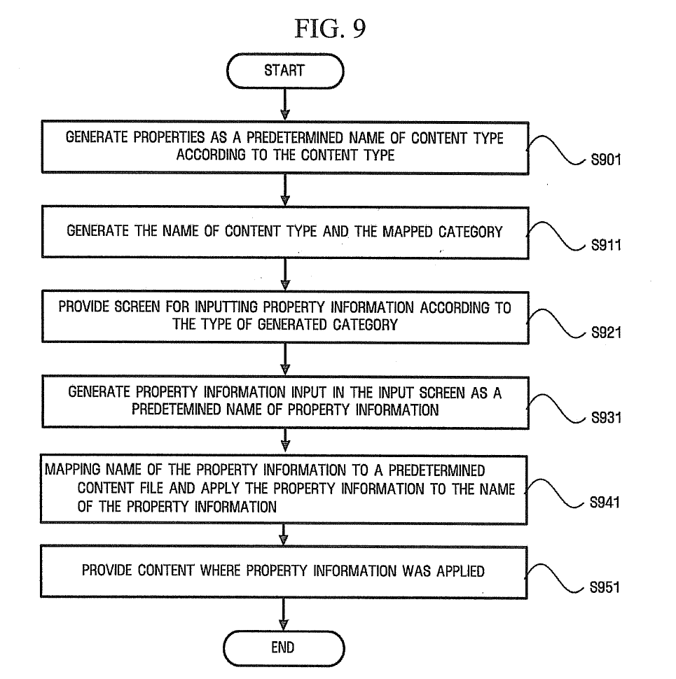

FIG. 9 is a flowchart of the method of managing content according to aspects of the present invention. The property-modeling unit 310 generates the properties such as a predetermined name of the content type according to the content type S901. Examples of the name are not limited and are used to differentiate different sets of DRM and/or billing information. Please refer to the explanation of FIG. 4 for further explanation of operation S901. The category-managing unit 330 generates a predetermined category mapped to the name of the content type S911. Please refer to the explanation of FIG. 5 for the detailed description thereof.

The UI-providing unit 320 provides screens in which property information values are input according to the type of the generated category S921. Please refer to FIGS. 6 to 8 for the detailed information. The property-information-managing unit 340 stores and manages the values of the property information input through the screen S931. Then, the mapping unit 350 maps the properties to a predetermined content file S941 designated in, for example, the physical file designation 820 of FIG. 8. Finally, the content file to which the property information is applied is provided to the user S951.

As described above, the method and apparatus for managing content produce one or more of the following and other effects. First, an independent method of providing information needed for DRM and billing services is provided to thereby provide a more effective service. Second, various DRM encryption standards can be applied through a convenient interface. Third, a plurality of sets of authority information and price models can be applied to the content file. Fourth, a variety of content types can be managed through a common database. Further, an additional database table for connecting the DRM and the billing service is not needed.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus for managing content, comprising:
a property-modeling unit to define properties in a predetermined format applicable to a predetermined content file according to content types;
a category-managing unit to generate and to manage categories mapped to the content type;
a user interface (UI) providing unit to output a screen through which property-information values for the defined properties are input according to the generated categories; and
a mapping unit to map and apply the property-information values to the predetermined content files,
wherein the property-information values comprise one or more sets of information including authority information of the content types and/or a price model of the content types and each set is capable of indicating both the authority information and the price model.

2. The apparatus of claim 1, further comprising a calling unit to call an external library needed for digital rights management (DRM) encryption according to a code input by a user.

3. The apparatus of claim 1, wherein the mapping unit maps a plurality of the property information values to the predetermined content file.

4. The apparatus of claim 1, wherein the mapping unit maps the content files to a content file of a higher level in a content-file tree structure.

5. The apparatus of claim 1, wherein the generated category is arranged at a position in a tree structure of generated categories.

6. A method of managing content, comprising:
defining properties in a predetermined format applicable to a predetermined content file according to content types;
generating categories to which the content types are mapped;
providing a screen through which property-information values for the defined properties are input according to the generated categories;
mapping the property-information values to the predetermined content file,
wherein the property-information values comprise one or more sets of information including authority information of the content types and/or a price model of the content types and each set of information is capable of indicating both the authority information and the price model.

7. The method of claim 6, further comprising calling an external library needed for DRM encryption according to an executable code input by a user.

8. The method of claim 6, further comprising mapping a plurality of property information values to the content file.

9. The method of claim 6, further comprising arranging the generated category at a position in a tree structure comprising generated categories.

10. The apparatus of claim 1, wherein the UI-providing unit further provides a screen through which a name of the content type and an explanation of the content type are input to define new content types.

11. The apparatus of claim 10, wherein the UI-providing unit further provides a screen through which the properties are defined according to the named content type to provide the authority information and/or the price model thereto.

12. The apparatus of claim 1, further comprising a managing unit to store and to manage the property-information values.

13. The apparatus of claim 1, wherein the price model includes billing information, and a same interface allows setting of and defining of the billing information.

14. The apparatus of claim 1, wherein the authority information includes digital rights management data to restrict use of the predetermined content file.

15. A computer-readable medium encoded with processing instructions implementing the method of claim 6 performed by a computer.

16. The method of claim 6, further comprising defining property values corresponding to the defined properties.

17. The method of claim 6, further comprising reviewing information regarding the managed content.

18. An apparatus for managing content, comprising:
a property-modeling unit to define properties in a predetermined format applicable to a predetermined content file according to content types, the content types being selectable between at least audio content, video content, and image content;
a category-managing unit to generate and to manage categories mapped to the content type, the generated categories being selectable between at least neutral, digital rights management (DRM), and billing;
a user interface (UI) providing unit to output a screen through which property-information values for the defined properties are input according to the generated categories so as to define at least the neutral, DRM, and billing categories; and
a mapping unit to map and to apply the property-information values to the predetermined content file,
wherein the property-information values comprise authority information of the content types and/or a price model of the content types and both the authority information and the price model are capable of being applied to the predetermined content file.

19. The apparatus of claim 18, wherein the predetermined content file is capable of being included in a plurality of content types.

20. The apparatus of claim 18, wherein the predetermined content file is capable of being included in a plurality of generated categories.

21. The apparatus of claim 18, wherein the predetermined content file is capable of being mapped to an other predetermined content file of at least one of a different content type and a different category.
